(19) United States
(12) Patent Application Publication
(10) Pub. No.: US 2021/0278806 A1
(43) Pub. Date: Sep. 9, 2021

(54) INTERCHANGEABLE WRISTWATCH

(71) Applicant: Sebastian Rios, East Haven, CT (US)

(72) Inventor: Sebastian Rios, East Haven, CT (US)

(21) Appl. No.: 17/248,698

(22) Filed: Feb. 3, 2021

Related U.S. Application Data
(60) Provisional application No. 62/985,564, filed on Mar. 5, 2020.

(51) Int. Cl. G04B 37/14; G04B 37/12

(52) U.S. Cl. CPC G04B 37/1486; G04B 37/127

(57) ABSTRACT

The present invention provides an interchangeable wristwatch including a wristwatch outer case comprising a front face and a rear door releasably coupled to the front face. The front face may comprise a transparent material. A receptacle is defined by the rear door and the front face, the receptacle being sized to accept a portable clock. The present invention provides an interchangeable watch that allows for a user to change the watch face relative to the bezel. The interchangeable watch is constructed and arranged for changing the watch face relative to the bezel, including a rear door which a user may open and switch out the watch. The interchangeable watch may include an easy to use watch band pin so that the watch band may easily be interchanged. The interchangeable wristwatch allows users to create their own watch look for multiple occasions and provides users a form of expression.

### CROSS-REFERENCE TO RELATED APPLICATION

This application claims the benefit of priority of U.S. provisional application No. 62/985,564, filed 5 Mar. 2020, the contents of which are herein incorporated by reference.

### BACKGROUND OF THE INVENTION

The present invention relates to watches and, more particularly, to an interchangeable wristwatch.

Changing a watch band requires an individual to struggle with removing a pin. Then one must find the proper watch band to match the watch face. In addition, currently the watch face cannot be interchanged with a bezel to provide a different look.

As can be seen, there is a need for an interchangeable wristwatch that allows a user to change the face of the watch.

### SUMMARY OF THE INVENTION

In one aspect, the present invention provides an interchangeable watch that allows for the user to change the watch face relative to the bezel.

In a further aspect, the present invention may provide an interchangeable watch constructed and arranged for changing the watch face relative to the bezel.

The watch includes a rear door which a user may open to remove the watch and switch out the watch. The door may include any suitable opening and closing mechanism. For example, the user may open the door via twist and pull or snap in and out, and switch out the watch.

In an additional aspect, the present invention also includes an easy to use watch band pin so that the watch band may easily be interchanged.

In yet another aspect, the present invention allows the user to create their own look for casual, business casual and business occasions. The present invention provides a form of expression for the user.

These and other features, aspects and advantages of the present invention will become better understood with reference to the following drawings, description and claims.

### BRIEF DESCRIPTION OF THE DRAWINGS

FIG. 1 is an exploded perspective view of an embodiment of the present invention;

FIG. 2 is an exploded front view of an embodiment of the present invention; and

FIG. 3 is an exploded perspective view of a pin of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

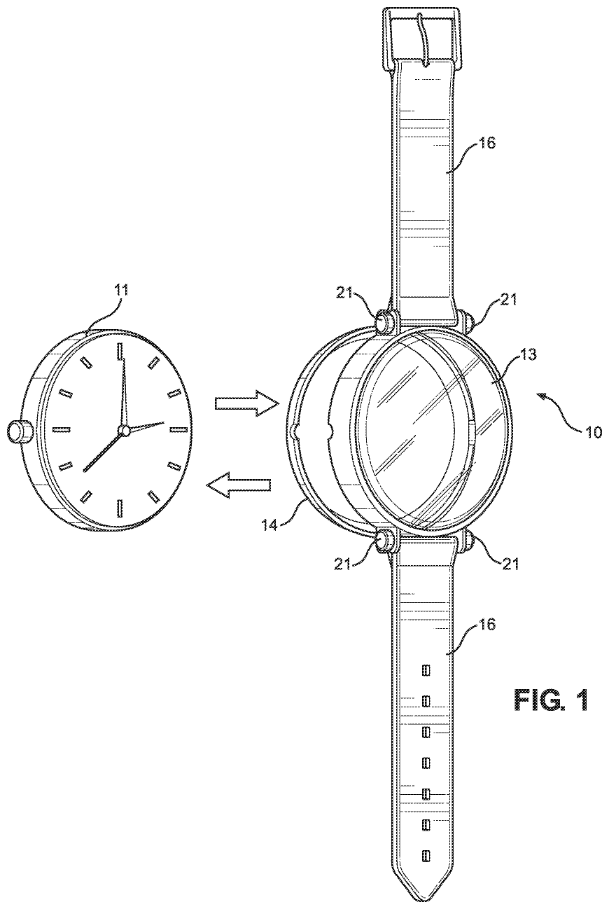

As used herein, “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1.

Furthermore, as there is no intention to be bound by any express or implied theory presented in the preceding technical field, background, brief summary or the following detailed description, it is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Broadly, an embodiment of the present invention provides an interchangeable watch that allows for the user to change the watch face relative to the bezel. The present invention may include a rear door in which a user may open and switch out the watch. The present invention also includes an easy to use watch band pin so that the watch band may easily be interchanged. The present invention allows the user to create their own look for casual, business casual and business occasions. The present invention provides a form of expression for the user.

The present invention may provide a wristwatch outer case comprising a front face comprising a transparent material; and a rear door releasably coupled to the front face, wherein a receptacle is defined in between the rear door and the front face sized to accept a portable clock. In an exemplary embodiment, the present invention includes an interchangeable wristwatch. The components of the interchangeable wristwatch may be made of any suitable material, fabricated by any suitable process. The components of the interchangeable wristwatch may further be of any suitable shape or size, and may have any suitable dimensions.

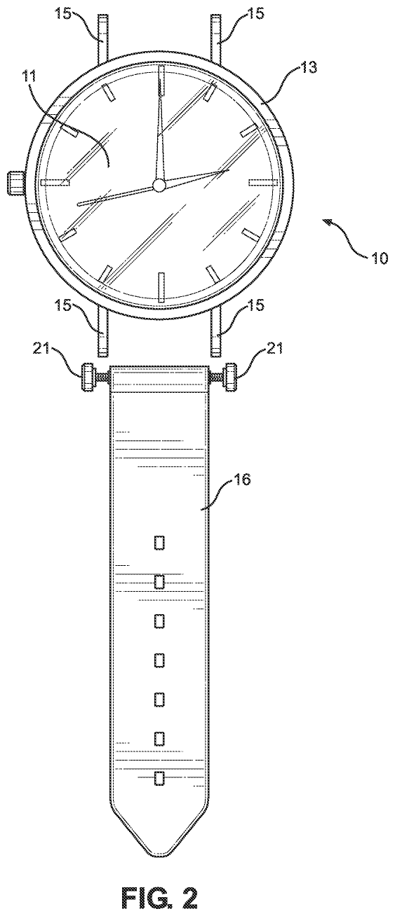

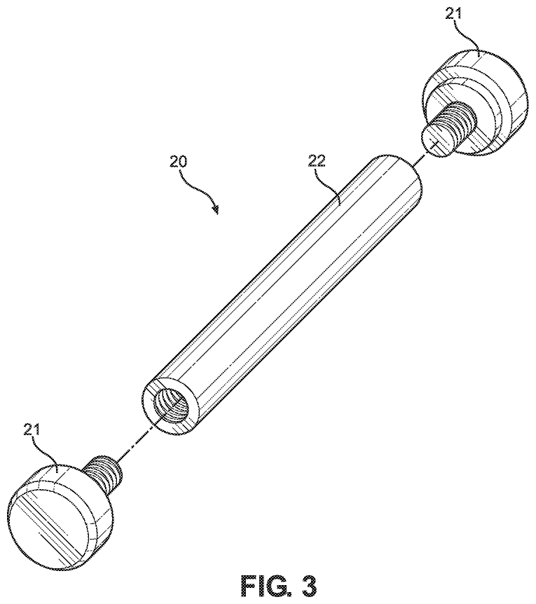

Referring now to FIGS. 1 through 3, in an exemplary embodiment, the interchangeable wristwatch includes an outer case 10 having a front face 13 and a rear door 14 defining a receptacle therebetween. The front face 13 may be made of a transparent material, such as crystal, plastic, glass, and the like. The front face 13 may further include the bezel of the watch circumferentially disposed around the transparent material. It can be seen that the case, the front face and bezel may be of any suitable size and geometric shape.

The rear door 14 is removably attached to the front face 13. The rear door allows for the removal and replacement of an interior component, such as, for example without limitation, a portable clock 11. The portable clock 11 fits within the receptacle. Therefore, a user may open the rear door 14, remove a current portable clock 11 within the receptacle and place a new portable clock 11 within the receptacle, thereby changing the look of the wristwatch.

The front face and rear door may be attached by any suitable connection, such as, for example without limitation, a threaded connection, a twist connection, a hinged connection, a snap fit connection or an interference press fit connection. The door may be opened by any suitable closure device. Nonlimiting examples of the manner in which the user may open the interchangeable wristwatch include, by unscrewing a threaded rear door, twisting and pulling the rear door having a twist connection, opening and rotating a hinged rear door, unsnapping a snap fit connection door, or pulling out an interference fit rear door. Then the user may remove and switch out the watch or clock for an alternative watch or clock.

In an exemplary embodiment, the present invention may further utilize wrist band pins 20. The wrist band pins 20 include a support tube 22 having opposing ends. Each of the opposing ends includes female threads. End screws 21 having male threads mechanically fasten to the opposing ends. The support tube 22 fits through a sleeve of the wrist bands 16. The outer case 10 includes a pair of protruding supports 15 on the top side and the bottom side. Each pair of protruding supports 15 includes aligned openings that align with the sleeve. The end screws fit through the aligned openings and into the opposing ends of the support tube 22, connecting the wrist band 16 to the outer case 10.

The pins allow the pin ends to clip in, securing the watch band. In some embodiments, a pull pin may also be used which allows for disconnection of the pin ends and the pin clips. When users of the watch decide they would like to create a new watch, they may simply open the rear door, remove the component or watch from the receptacle, and insert a new one. Simply pulling the pins and removing pin ends allows the user to quickly change the band and ends. Once pins are inserted into a new band and the new ends are fastened, the user simply clips the ends back into the clips. Hence, the user may create a new watch of their desire.

In an exemplary embodiment, the present invention provides a wristwatch outer case comprising a front face comprising a transparent material; and a rear door releasably coupled to the front face, wherein a receptacle is defined in between the rear door and the front face sized to accept a portable clock.

In one embodiment, an interchangeable wristwatch comprises a wristwatch outer case having a top side, a bottom side, a right side and a left side. The wristwatch outer case comprises a front face; a rear door releasably coupled to the front face; and an interior receptacle defined by the rear door and the front face.

In some embodiments, the interchangeable wristwatch has a front face comprising a transparent material.

In some embodiments, the interior receptacle defined by the rear door and the front face is sized to accept a portable clock. The portable clock may be removably located within the interior receptacle.

The interchangeable wristwatch further comprises at least one pair of protruding supports located on the wristwatch outer case, a wristwatch band constructed and arranged for removable securement to the wristwatch outer case, and at least one wristwatch band pin constructed and arranged for removable securement to the at least one pair of protruding supports, the at least one pair of protruding supports being constructed and arranged to removably securely receive the at least one wristwatch band pin.

In some embodiments, the at least one pair of protruding supports located on the wristwatch outer case comprises a first pair of protruding supports located at the top side of the wristwatch outer case, and a second pair of protruding supports located at the bottom side of the wristwatch outer case.

In some embodiments, the at least one wristwatch band pin comprises a first wristwatch band pin constructed and arranged for removable securement to the first pair of protruding supports, and a second wristwatch band pin constructed and arranged for removable securement to the second pair of protruding supports; and the wristwatch band comprises a first watch band portion constructed and arranged for removable connection to the first pair of protruding supports, and a second watch band portion constructed and arranged for removable connection to second pair of protruding supports.

In some embodiments, each said first and second wristwatch band pin comprises a support tube having a first end with female threads and a second end with female threads; and a first end screw with male threads and a second end screw with male threads, the first end screw and the second end screw being constructed and arranged to mechanically and releasably fasten to the first end and the second end, respectively. The first watch band portion and second watch band portion each further comprise a proximal watch band end, a distal watch band end, and a proximal sleeve located at each said proximal watch band end, each said proximal sleeve having a first proximal sleeve opening and a second proximal sleeve opening. The support tube of each said first and second wristwatch band pin is constructed and arranged to fit through the proximal sleeve of said first and second watch band portion, respectively. Each protruding support of said first pair and second pair of protruding supports further comprises an aligned opening constructed and arranged to align with one of said proximal sleeve openings. Each said end screw fits through one of said aligned openings and into one of said support tubes for threaded connection between the support tube female threads and end screw male threads to securely and removably retain the watch band to the wristwatch outer case.

In some embodiments, the at least one wristwatch band pin comprises a pull pin operably connected to the at least one wristwatch band pin, the pull pin being constructed and arranged to removably secure the at least one wristwatch band pin between the at least one pair of protruding supports.

It should be understood, of course, that the foregoing relates to exemplary embodiments of the invention and that modifications may be made without departing from the spirit and scope of the invention as set forth in the following claims.

What is claimed is:

1. A wristwatch outer case comprising:
a front face comprising a transparent material; and
a rear door releasably coupled to the front face, wherein a receptacle is defined in between the rear door and the front face sized to accept a portable clock.

2. An interchangeable wristwatch comprising:
a wristwatch outer case having a top side, a bottom side, a right side and a left side, the wristwatch outer case comprising: a front face; a rear door releasably coupled to the front face; and an interior receptacle defined by the rear door and the front face.

3. The interchangeable wristwatch of claim 2 wherein the front face comprises a transparent material.

4. The interchangeable wristwatch of claim 3 wherein the interior receptacle defined by the rear door and the front face is sized to accept a portable clock.

5. The interchangeable watch of claim 4 further comprising a portable clock removably located within the interior receptacle.

6. The interchangeable wristwatch of claim 2 further comprising:
at least one pair of protruding supports located on the wristwatch outer case;
a wristwatch band constructed and arranged for removable securement to the wristwatch outer case; and
at least one wristwatch band pin constructed and arranged for removable securement to the at least one pair of protruding supports, the at least one pair of protruding supports being constructed and arranged to removably securely receive the at least one wristwatch band pin.

7. The interchangeable watch of claim 6 wherein:
the at least one pair of protruding supports located on the wristwatch outer case comprises a first pair of protruding supports located at the top side of the wristwatch outer case, and a second pair of protruding supports located at the bottom side of the wristwatch outer case;
the at least one wristwatch band pin comprises a first wristwatch band pin constructed and arranged for removable securement to the first pair of protruding supports, and a second wristwatch band pin constructed and arranged for removable securement to the second pair of protruding supports; and
the wristwatch band comprises a first watch band portion constructed and arranged for removable connection to the first pair of protruding supports, and a second watch band portion constructed and arranged for removable connection to second pair of protruding supports.

8. The interchangeable watch of claim 7:
wherein each said first and second wristwatch band pin comprises:
a support tube having a first end with female threads and a second end with female threads; and
a first end screw with male threads and a second end screw with male threads, the first end screw and the second end screw being constructed and arranged to mechanically and releasably fasten to the first end and the second end respectively;
wherein the first watch band portion and second watch band portion each further comprise a proximal watch band end, a distal watch band end, and a proximal sleeve located at each said proximal watch band end, each said proximal sleeve having a first proximal sleeve opening and a second proximal sleeve opening; and
wherein the support tube of each said first and second wristwatch band pin is constructed and arranged to fit through the proximal sleeve of said first and second watch band portion, respectively;
wherein each protruding support of said first pair and second pair of protruding supports further comprises an aligned opening constructed and arranged to align with one of said proximal sleeve openings; and
wherein each said end screw fits through one of said aligned openings and into one of said support tubes for threaded connection between the support tube female threads and end screw male threads to securely and removably retain the watch band to the wristwatch outer case.

9. The interchangeable watch of claim 6 wherein the at least one wristwatch band pin comprises a pull pin operably connected to the at least one wristwatch band pin, the pull pin being constructed and arranged to removably secure the at least one wristwatch band pin between the at least one pair of protruding supports.
